(19) United States
(12) Patent Application Publication
(10) Pub. No.: US 2019/0070901 A1
(43) Pub. Date: Mar. 7, 2019

(54) TIRE TRACTION MAT

(71) Applicant: Maria Otero, Flushing, NY (US)

(72) Inventor: Maria Otero, Flushing, NY (US)

(21) Appl. No.: 16/122,888

(22) Filed: Sep. 6, 2018

Related U.S. Application Data
(60) Provisional application No. 62/554,953, filed on Sep. 6, 2017.

(51) Int. Cl. B60B 39/12

(52) U.S. Cl. CPC B60B 39/12; B60B 2900/721

(57) ABSTRACT

A tire traction mat comprising: a main panel and a plurality of spikes. The main panel includes: a top surface; a bottom surface; a front edge portion; a back edge portion; and two side edge portions. Wherein the plurality of spikes are spaced from one another, attached to the bottom surface of the main panel, adapted to releasably engage a supporting surface, and increase friction between the main panel and the supporting surface. Wherein the tire traction mat is adapted to be placed upon a supporting surface and provide a frictional surface for a tire of a vehicle to roll upon. A tire traction kit is also disclosed comprising: a tire traction mat container; a closing member; and at least one tire traction mat.

### CROSS-REFERENCE TO RELATED APPLICATION

The present application is related to and claims priority from prior provisional application Ser. No. 62/554,953, filed Sep. 6, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of traction mats and more specifically relates to a tire traction mat adapted to be placed upon a supporting surface and provide a frictional surface for a tire of a vehicle to roll upon that have become stuck in snow, ice, or mud.

### 2. Description of the Related Art

Consider, for example, that for millions of motorists in the nation's colder regions, winter after the first couple of major snowstorms is less a Christmas-card scene of silent, snow-swept serenity than a constant and bitter battle with the elements. Snow may blanket the landscape in virginal white, but in order for you to get in or out of your house, or to go anywhere, you've got to be ready to drive on, or get your car out of ice or snow. And if you're stuck in ice or snow, even the best snow-tires won't get you out on their own. What motorists need, then is a simple, easily carried and deployed tool for getting unstuck from snow or ice.

Snow tires-also called winter tires-are tires designed for use on snow and ice. Snow tires have a tread design with bigger gaps than those on summer tires, increasing traction on snow and ice. Traction, or tractive force, is the force used to generate motion between a body and a tangential surface, through the use of dry friction, though the use of shear force of the surface is also commonly use. Snow tires operate on a variety of surfaces, including pavement (wet or dry), mud, ice, or snow. The tread design of snow tires is adapted primarily to allow penetration of the snow into the tread, where it compacts and provides resistance against slippage:^{[4]} The snow strength developed by compaction depends on the properties of the snow, which depend on its temperature and water content—wetter, warmer snow compacts better than dry, colder snow up to a point where the snow is so wet that it lubricates the tire-road interface. Unfortunately, not every driver or every vehicle can be equipped or a user has the option or access to snow tires.

Various attempts have been made to solve problems found in traction mats art. Among these are found in: U.S. Pat. No. 4,210,280 to Robert J. Reisner; U.S. Pat. No. 1,863,316 to Towner K. Webster Jr; and U.S. Pat. No. 6,394,362 to Patrick J. Kramr. This prior art is representative of traction mats that are used underneath tires to free a vehicle in mud or snow.

Ideally, a tire traction mat should be user-friendly and safe in-use and yet would operate reliably and be manufactured at a modest expense. Thus, a need exists for a tire traction mat adapted to be placed upon a supporting surface and provide a frictional surface for a tire of a vehicle to roll upon that have become stuck in snow, ice, or mud to avoid the above-mentioned problems.

### BRIEF SUMMARY OF THE INVENTION

In view of the foregoing disadvantages inherent in the known of traction mat device art, the present invention provides a novel Tire Traction Mat. The general purpose of the present invention, which will be described subsequently in greater detail is to provide a tire traction mat adapted to be placed upon a supporting surface and provide a frictional surface for a tire of a vehicle to roll upon that have become stuck in snow, ice, or mud.

A tire traction mat comprising: a main panel and a plurality of spikes. The main panel includes: a top surface; a bottom surface; a front edge portion; a back edge portion; and two side edge portions. Wherein the two side edge portions extend between the front and back edge portions. Wherein the main panel is formed having a thickness between the top and bottom surfaces.

Wherein the plurality of spikes are spaced from one another, attached to the bottom surface of the main panel, adapted to releasably engage a supporting surface, and increase friction between the main panel and the supporting surface. Wherein the tire traction mat is adapted to be placed upon a supporting surface and provide a frictional surface for a tire of a vehicle to roll upon.

A tire traction kit is also disclosed comprising: a tire traction mat container; a closing member; and at least one tire traction mat. The tire traction mat container includes: at least one side wall including an upper edge portion. Wherein the at least one side wall forms an interior volume. Wherein the at least one side wall forms an opening adapted to allow at least one tire traction mat to be stored within said interior volume. Wherein the closing member is adapted to releasably close the opening.

The at least one tire traction mat comprises: a main panel and a plurality of spikes. Wherein the at least one tire traction mat is adapted to be placed upon a supporting surface and provide a frictional surface for a tire of a vehicle to roll upon. Wherein the at least one tire traction mat is adapted to be rolled up and stored within the tire traction mat container.

The present invention holds significant improvements and serves as a tire traction mat. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a Tire Traction Mat, constructed and operative according to the teachings of the present invention.

FIG. 1 shows a top perspective view illustrating a Tire Traction Mat according to an embodiment of the present invention.

FIG. 2 is a bottom perspective view illustrating the Tire Traction Mat according to an embodiment of the present invention of FIG. 1.

FIG. 3 is a perspective view illustrating Tire Traction Mat in an in-use condition according to an embodiment of the present invention of FIG. 1.

FIG. 4A is a perspective view illustrating a tire traction kit including a tire traction mat container, a closing member having a drawstring; and at least one tire traction mat according to an embodiment of the present invention of FIG. 1.

FIG. 4B is a perspective view illustrating a tire traction kit including a tire traction mat container, a closing member having a cap; and at least one tire traction mat according to an embodiment of the present invention of FIG. 1.

FIG. 5 is a perspective view illustrating two tire traction mats of the tire traction kit according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a traction mat device and more particularly to a Tire Traction Mat. The general purpose of the present invention, which will be described subsequently in greater detail is to provide a tire traction mat adapted to be placed upon a supporting surface and provide a frictional surface for a tire of a vehicle to roll upon that have become stuck in snow, ice, or mud

Generally speaking, the Tire Traction Mat comprises a specially designed mat with studs or spikes on the underside, and a high-traction rubber gripping surface on the topside—designed to provide the tire-traction necessary to get a vehicle unstuck from snow, ice, or mud. The Tire Traction Mat would be a special mat—with studs or spikes on the underside, and a high-traction rubber gripping surface on the topside—designed to provide the tire-traction necessary to get a vehicle unstuck from snow, ice, or mud.

The Tire Traction Mat would be fabricated of natural or synthetic rubber, with dimensions of 24 inches in width and perhaps 36 to 40 inches in length. The outer 4 inches of this rectangular mat will be beveled, this bevel creating a short “ramp” that will permit the mat to be inserted under a tire's edge and enable the tire to climb onto the body of the Tire Traction Mat more easily. The remainder of the top surface of the rubber mat will be finished with a ridged, contoured, high-traction gripping surface. The underside of the Tire Traction Mat will feature a continuous, regular array of 4-inch metal spikes, designed to penetrate snow, ice, or mud and to provide an extraordinary “anchor” for the mat, which will stay in place as the vehicle's drive-tires move up, onto, and over it.

When not in use, the Tire Traction Mat would be rolled up lengthwise, so that it makes a cylindrical package 24 inches in length. This package would then be stored in its own drawstring carry-bag or container; and each Tire Traction Mat retail package would contain two Tire Traction Mat mats, with instructions for use.

In the Tire Traction Mat, consumer/motorists would have an easy-to-use, reliable tool for getting themselves unstuck from snow, ice, or mud. Easy to unroll and deploy when needed, the Tire Traction Mat spikes would provide the anchorage needed to effectively stay in place against (and on top of) a substrate of snow, ice, or mud, and the top gripping surface would provide the traction necessary for the tires to move from their stuck position. Clever in conception and exceptionally thoughtful in design, the Tire Traction Mat would enable motorists—without calling a tow-truck—to extricate their vehicles when stuck; and this essential automotive emergency accessory should find a wide and enthusiastic reception in the automotive aftermarkets of both America, and the world.

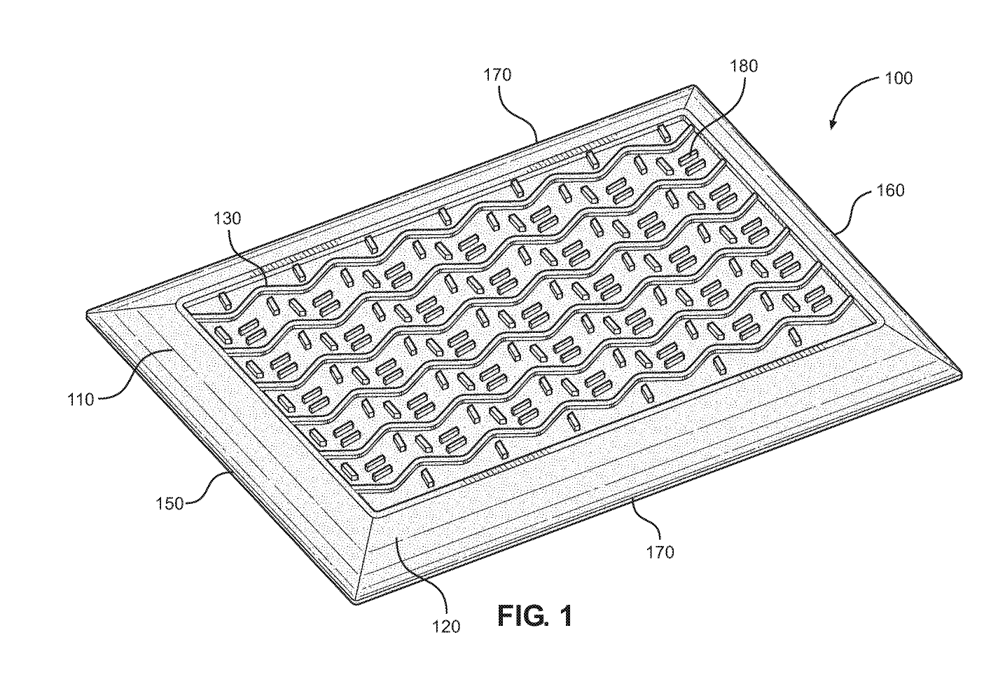

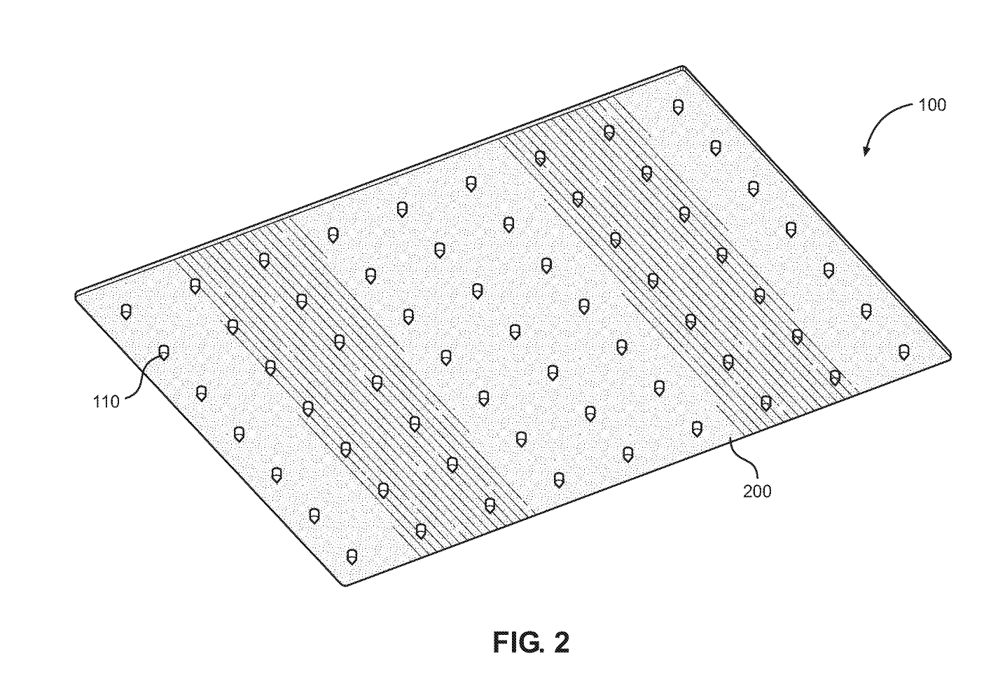

Referring to the drawings by numerals of reference there is shown in FIGS. 1-3, perspective views illustrating tire traction mat 100 according to an embodiment of the present invention.

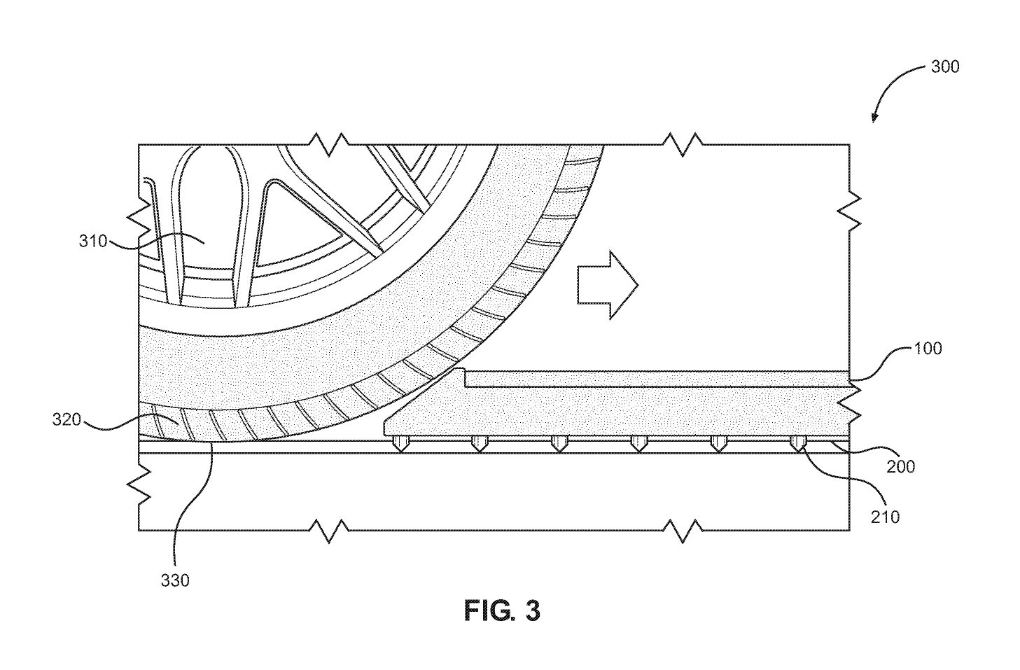

Tire traction mat 100 comprising: main panel 110 and plurality of spikes 210. Main panel 110 includes: top surface 120; bottom surface 200; front edge portion 150; back edge portion 160; and two side edge portions 170. Wherein top surface 120 is formed having spaced ridges 130 thereon adapted to increase friction between tire 320 of vehicle 310 and tire traction mat 100. Wherein two side edge portions 170 extend between front edge portion 150 and back edge portion 160. Wherein main panel 110 is formed having a thickness between top surface 120 and bottom surface 200. Wherein front edge portion 150, back edge portion 160, and two side edge portions 170 are formed having beveled surface 180 adapted to be inserted under tread portion 330 of tire 320 of vehicle 310 and provide a ramp surface for tire 320 of vehicle 310 to roll up upon and onto top surface 120 of tire traction mat 100 as shown in in-use condition 300 of FIG. 3.

Wherein main panel 110 is formed from a material chosen from a list of materials consisting of rubber, synthetic rubber, and plastic. Wherein main panel 110 is formed having dimensions including 24 inches in width and between 36 and 40 inches in length.

Wherein plurality of spikes 210 are spaced from one another, attached to the bottom surface 200 of main panel 110, adapted to releasably engage supporting surface 350, and increase friction between main panel 110 and supporting surface 350. Wherein s plurality of spikes 210 each have a length of 4 inches. Wherein plurality of spikes 210 are formed from a material chosen from a list of materials consisting of steel, ceramic, and plastic. Wherein tire traction mat 100 is adapted to be placed upon supporting surface 350 and provide a frictional surface for tire 320 of vehicle 310 to roll upon as shown in in-us condition 300 of FIG. 3.

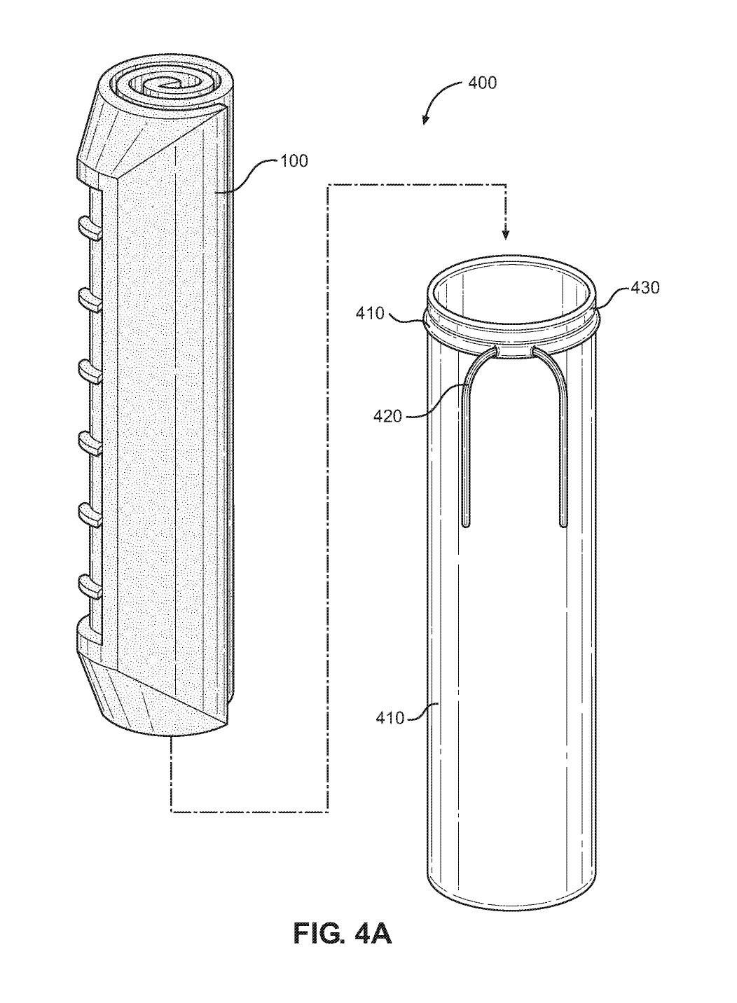

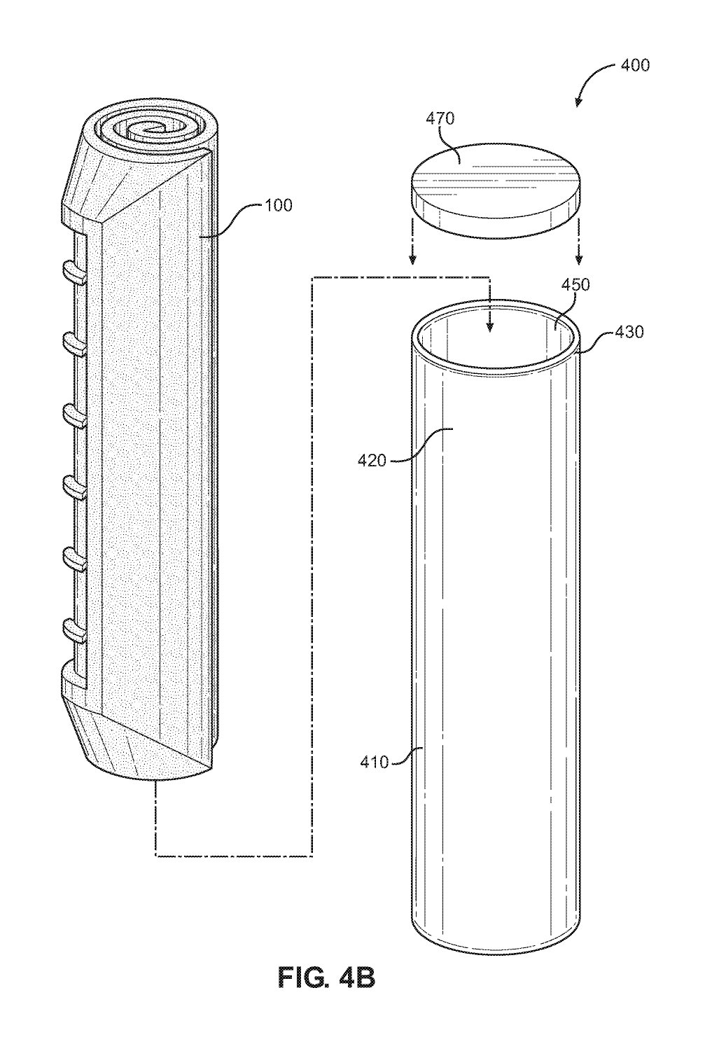

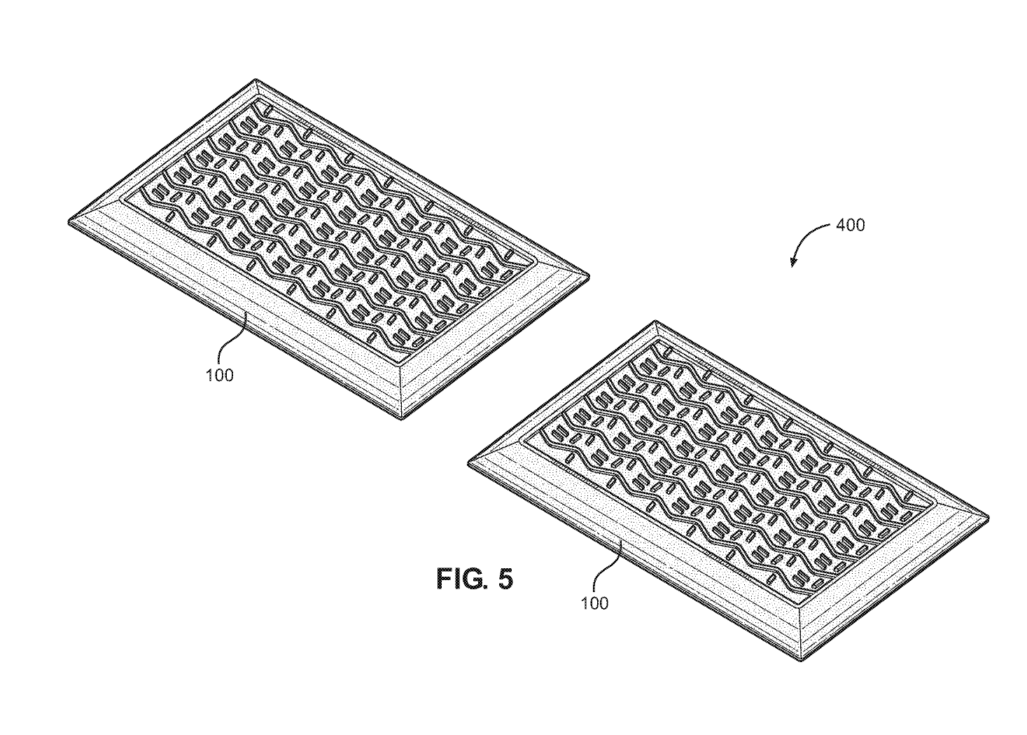

Referring to the drawings by numerals of reference there is shown in FIGS. 4-5, perspective views illustrating tire traction kit 400 according to an embodiment of the present invention.

Tire traction kit 400 comprising: tire traction mat container 410; closing member 450; and at least one tire traction mat 100. Tire traction mat container 410 includes: at least one side wall 420 including upper edge portion 430. Wherein at least one side wall 420 forms interior volume 424. Wherein at least one side wall 420 forms opening 426 adapted to allow at least one tire traction mat 100 to be stored within interior volume 424. Wherein closing member 450 is adapted to releasably close opening 426. Wherein closing member 450 of tire traction mat container 410 is formed as drawstring 460 attached along a length of upper edge portion 430 of at least one side wall 420 of tire traction mat container 410 as shown in FIG. 4A. Wherein closing member 450 of tire traction mat container 410 is formed as cap 470 adapted to be releasably attached to upper edge portion 430 of at least one side wall 420 of tire traction mat container 410 as shown in FIG. 4B.

At least one tire traction mat 100 comprises: main panel 110 and plurality of spikes 210. Wherein at least one tire traction mat 100 is adapted to be placed upon supporting surface 350 and provide a frictional surface for tire 320 of vehicle 310 to roll upon. Wherein at least one tire traction mat 100 is adapted to be rolled up and stored within tire traction mat container 410. Wherein there are two tire traction mats 100 as shown in FIG. 5.

The kit has instructions such that functional relationships are detailed in relation to the structure of the invention (such that the invention can be used, maintained, or the like in a preferred manner). Tire traction mat 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A tire traction mat comprising:
a main panel including:
a top surface;
a bottom surface;
a front edge portion;
a back edge portion;
two side edge portions;
wherein said two side edge portions extend between said front and back edge portions;
wherein said main panel is formed having a thickness between said top and bottom surfaces;
a plurality of spikes;
wherein said plurality of spikes are spaced from one another, attached to said bottom surface of said main panel, adapted to releasably engage a supporting surface, and increase friction between said main panel and said supporting surface;
wherein said tire traction mat is adapted to be placed upon a supporting surface and provide a frictional surface for a tire of a vehicle to roll upon.

2. The tire traction mat of claim 1, wherein said top surface is formed having spaced ridges thereon adapted to increase friction between a tire of a vehicle and said tire traction mat.

3. The tire traction mat of claim 1, wherein said front, back, and two side edge portions are formed having a beveled surface adapted to be inserted under the tread portion of a tire of a vehicle and provide a ramp surface for said tire of a vehicle to roll up upon and onto said top surface of said tire traction mat.

4. The tire traction mat of claim 1, wherein said main panel is formed from a material chosen from a list of materials consisting of rubber, synthetic rubber, and plastic.

5. The tire traction mat of claim 1, wherein said main panel is formed having dimensions including 24 inches in width and between 36 and 40 inches in length.

6. The tire traction mat of claim 1, wherein said plurality of spikes each have a length of 4 inches.

7. The tire traction mat of claim 1, wherein said plurality of spikes are formed from a material chosen from a list of materials consisting of steel, ceramic, and plastic.

8. A tire traction kit comprising:
a tire traction mat container including:
at least one side wall including:
an upper edge portion;
wherein said at least one side wall forms an interior volume;
wherein said at least one side wall forms an opening adapted to allow at least one tire traction mat to be stored within said interior volume; and
a closing member;
wherein said closing member is adapted to releasably close said opening; and
at least one tire traction mat comprising:
a main panel including:
a top surface;
a bottom surface;
a front edge portion;
a back edge portion;
two side edge portions;
wherein said two side edge portions extend between said front and back edge portions;
wherein said main panel is formed having a thickness between said top and bottom surfaces;
a plurality of spikes;
wherein said plurality of spikes are spaced from one another, attached to said bottom surface of said main panel, adapted to releasably engage a supporting surface, and increase friction between said main panel and said supporting surface;
wherein said at least one tire traction mat is adapted to be placed upon a supporting surface and provide a frictional surface for a tire of a vehicle to roll upon; and
wherein said at least one tire traction mat is adapted to be rolled up and stored within said tire traction mat container.

9. The tire traction kit of claim 8, wherein said top surface of said at least one tire traction mat is formed having spaced ridges thereon adapted to increase friction between a tire of a vehicle and said tire traction mat.

10. The tire traction kit of claim 8, wherein said front, back, and two side edge portions of said at least one tire traction mat are formed having a beveled surface adapted to be inserted under the tread portion of a tire of a vehicle and provide a ramp surface for said tire of a vehicle to roll up upon and onto said top surface of said tire traction mat.

11. The tire traction kit of claim 8, wherein said main panel of said at least one tire traction mat is formed from a material chosen from a list of materials consisting of rubber, synthetic rubber, and plastic.

12. The tire traction kit of claim 8, wherein said main panel of said at least one tire traction mat is formed having dimensions including 24 inches in width and between 36 and 40 inches in length.

13. The tire traction kit of claim 8, wherein said plurality of spikes of said at least one tire traction mat each have a length of 4 inches.

14. The tire traction kit of claim 8, wherein said plurality of spikes of said at least one tire traction mat are formed from a material chosen from a list of materials consisting of steel, ceramic, and plastic.

15. The tire traction kit of claim 8, wherein said closing member of said tire traction mat container is formed as a drawstring attached along a length of said upper edge portion of said at least one side wall of said tire traction mat container.

16. The tire traction kit of claim 8, wherein said closing member of said tire traction mat container is formed as a cap adapted to be releasably attached to said upper edge portion of said at least one side wall of said tire traction mat container.

17. The tire traction kit of claim 8, wherein there are two tire traction mats.
